(19) United States
(12) Patent Application Publication
(10) Pub. No.: US 2026/0099141 A1
(43) Pub. Date: Apr. 9, 2026

(54) GENERATING INDUSTRIAL PROCESS FLOW DIAGRAMS USING GENERATIVE AI AND IMAGE RECOGNITION

(71) Applicant: Honeywell International Inc., Charlotte, NC (US)

(72) Inventors: Sandhya Beejady, Bengaluru (IN); Rajapriyan Thambidurai, Bangalore (IN); Sridhar S, Bangalore (IN); Dhandapani Krishnasamy, Hosur (IN)

(73) Assignee: Honeywell International Inc., Charlotte, NC (US)

(21) Appl. No.: 18/907,102

(22) Filed: Oct. 4, 2024

(51) Int. Cl. G05B 23/02

(52) U.S. Cl. CPC G05B 23/0286; G05B 23/0216

(57) ABSTRACT

Systems and methods for generating industrial process flow diagrams using generative AI and image recognition are described herein. In certain embodiments, a system includes memory devices that stores a cognitive services model trained to determine whether image data represents process information; and a generative model trained to generate process diagram information from the image data. The system also includes processors that receive the image data; and execute the cognitive services model to determine whether the image data contains information associated with a process. When the cognitive services model determines that the image data contains the information associated with the process, the processors are also execute the generative model using the image data to generate the process diagram information. Further, the processors provide the process diagram information to a diagram visualization program, wherein the diagram visualization program generates a diagram from the process diagram information.

### BACKGROUND

Many industrial fields implement complex processes to produce products or perform manufacturing tasks. These processes often require advanced planning and design to ensure the industrial tasks are performed correctly and replicable. As part of designing these complex processes, drawings have been created using hand drafting or computer-aided design (CAD programs) to capture these processes and convey the process design to those who will implement the process. After the drawings have been created, they are often provided to individuals who convert some or all of the drawings into process flow diagrams.

### SUMMARY

Systems and methods for generating industrial process flow diagrams using generative AI and image recognition are described herein. In certain embodiments, a system includes one or more memory devices configured to store a cognitive services model trained to determine whether image data represents process information; and a generative model trained to generate process diagram information from the image data. The system also includes one or more processors configured to receive the image data; and execute the cognitive services model to determine whether the image data contains information associated with a process. When the cognitive services model determines that the image data contains the information associated with the process, the processors are also configured to execute the generative model using the image data to generate the process diagram information. Further, the processors are configured to provide the process diagram information to a diagram visualization program, wherein the diagram visualization program generates a diagram from the process diagram information.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a diagram illustrating the creation of process flow diagrams from process and instrumentation diagrams according to an aspect of the present disclosure;

FIG. 2 is a block diagram of a system for using machine learning models to generate process flow diagrams from process and instrumentation diagrams according to an aspect of the present disclosure;

FIG. 3 is a flowchart diagram of a method for updated PFD data for PFDs generated by machine learning models according to an aspect of the present disclosure;

FIG. 4 is a flowchart diagram of a method for validating a generative model using updated PFD data according to an aspect of the present disclosure; and

FIG. 5 is a flowchart diagram of a method for generating industrial process flow diagrams using generative AI and image recognition according to an aspect of the present disclosure.

Per common practice, the drawings do not show the various described features according to scale, but the drawings show the features to emphasize the relevance of the features to the example embodiments.

### DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Embodiments described herein are drawn to systems and methods for generating industrial process flow diagrams (PFDs) using generative AI and image recognition. In particular, drawings are provided to a system that can read the drawing and generate one or more process flow diagrams from the drawing. For example, a user may provide an image file to the system. The system then determines whether the image file contains data that can be rendered as a PFD. If the image file contains renderable data, the system generates renderable data as a PFD.

Process flow diagrams are typically created using an involved process that requires significant human interpretation. As described herein, process flow diagrams refer to graphical representations of the components involved in a process. Typically, they represent processes in industrial fields that include but are not limited to oil and gas, mining and metallurgy, chemical engineering, biotechnology, pharmaceuticals, and many other endeavors that attempt to model processes. Process flow diagrams are helpful as they help individuals more clearly understand the employed process. Process flow diagrams are also used to simulate the process in a software environment.

System designers and engineers often derive the PFDs from process and instrumentation diagrams (PID) when creating process flow diagrams. As described herein, a PID is a detailed system schematic, often detailing instrumentation, control devices, connections, and comprehensive process information. As PIDs contain ample information to convey system information, PFDs are derived from the PIDs to more clearly convey key aspects of processes employed by systems depicted by PIDs. Also, the PFDs are used to simulate the process in software environments.

To derive the PFDs, system designers and engineers rely on the processes and related information being depicted clearly in the associated PID. To clearly convey information about systems in PIDs, drafters use symbols defined according to standards specified by standards bodies. For example, the Instrumentation Society of America defines symbols drafters use to convey information through PIDs. The symbols defined by these governing bodies may define components such as boilers, reactors, distillers, and other components commonly employed in industrial and manufacturing processes. Also, the symbols may specify how to connect the various components and the relationships implied by the depicted connections.

However, creating a PFD from a PID requires that the individual creating the PFD is familiar with the depicted symbols and the meaning of the information conveyed through the contextual use of the symbol. As the set of defined symbols is extensive, it takes extensive training to familiarize an individual with the standard symbols. Also, it takes significant effort to understand the PIDs and ensure they are correctly depicted in resultant PFDs.

Accordingly, as described herein, machine learning and image recognition algorithms are used to generate PFDs from PIDs. These algorithms are particularly well suited to this effort because PIDs are based on well-defined inputs (the relatively static defined standard symbol sets) that map to well-defined outputs within PFDs. Also, many PIDs and PFDs have been created throughout history that employ the defined standard symbol sets, resulting in significant training, validation, and testing data sets. As the outcome of the generative model is still reviewable by humans, there is tolerance for error and the possibility of further training based on human-made corrections.

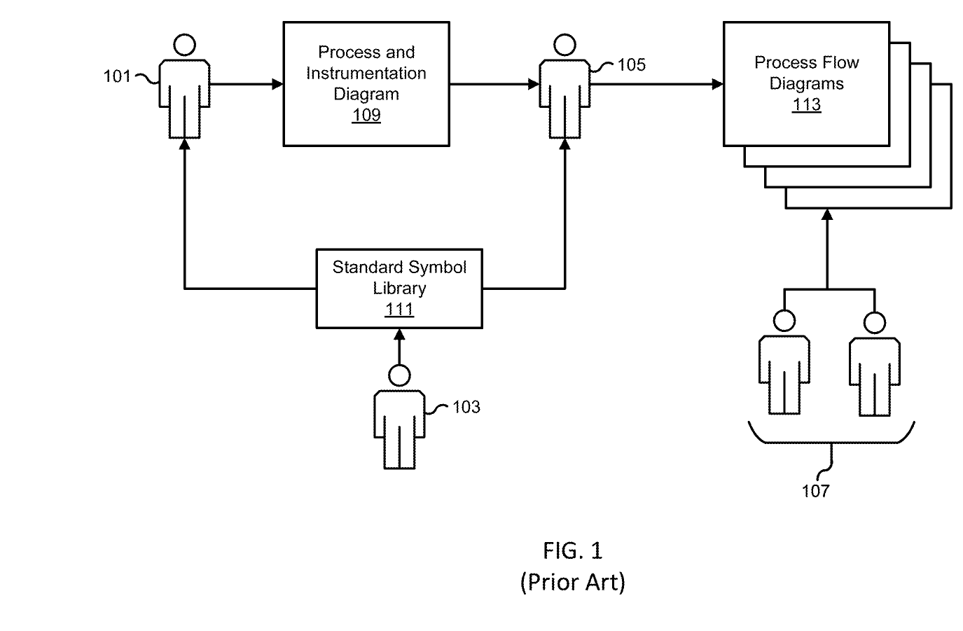

FIG. 1 is a block diagram illustrating a general system 100 for creating process flow diagrams (PFDs) 113. As described herein, a PFD 113 refers to a diagram that represents the flow of material through a process and the major components used to implement the process. PFDs 113 are often used in many industries including chemical engineering, manufacturing, power generation, pharmaceuticals, mining, etc. PFDs 113 are used in these many industries because they capably provide an overview of the major steps involved in a given process. In particular, they can illustrate how raw materials can be transformed into final products as they move through different equipment and pass through different stages of the illustrated process.

Often, PFDs 113 are derived from diagrams illustrating the detailed characteristics of a system that performs the process illustrated in a given PFD 113. These detailed diagrams, known as process and instrumentation diagrams (PIDs) 109 are created to show details about the control systems and instrumentations used to implement a process. PIDs 109 often focus on specific instruments, control loops, and how individual components are connected. Often, engineers and other process designers 101 use PIDs 109 to lay out the details of equipment, connections, and instrumentation in sufficient detail to enable others to assemble and operate the designed system. Also, PIDs 109 depict a system in sufficient detail to allow operators to understand and operate the process and components involved with monitoring the system and troubleshooting any issues that arise.

When designing many processes and the systems that implement those processes, PIDs 109 are used to provide a detailed depiction of a given system, and PFDs 113 are used to provide a high-level depiction of process flows and major equipment. Where a PID 109 can be used to correctly assemble and operate a system, the amount of detail often depicted in a PID 109 can make it difficult to quickly identify the basic steps of a process, making it difficult for process stakeholders to understand process sequences, equipment used in the process, and the flow of materials through the process. As such, the high-level depictions of a process within a PFD 113 help stakeholders understand the basics of the process so that more stakeholders can provide feedback and participate in the design of a given system.

Further, because PFDs 113 provide a high-level view focused on process flow, they are more suitable for simulations than the detailed depictions found in PIDs 109. Software can use PFDs 113 to simulate the movement of materials, the material interactions, and state changes as the materials progress through the system. Further, software can use PFDs 113 to model quantitative characteristics of the process. Engineers and other users 107 may use these simulations to increase their understanding of the system and the processes implemented by the system.

As PFDs 113 are derived from PIDs 109, to create a PFD 113, first, an engineer or other system designer 101 creates one or more PIDs 109 for a system. When creating a PID 109, the system designer 101 will typically depict the system using component symbols, connection labels, and other symbols in a drafting program (like a CAD program) or on paper. To ensure that PIDs 109 are understandable by potential stakeholders, the symbols used within a PID 109 are drawn from a standard symbol library 111. As used herein, the standard symbol library 111 is a library of symbols and notation defined according to industry standards to ensure consistent interpretation of PIDs across projects, companies, and industries. For example, organizations like the ISA, ISO, ANSI, and others define symbols that can represent different components and functions within a PID 109. Some standard symbols libraries 111 can include symbols that represent equipment, piping, valves, instruments, and control systems used in a process. These standard symbol libraries 111 are designed by standards associations 103 and promulgated for use by system designers 101.

In addition to the system designers 101 using the symbols defined in the standard symbol library 111 to depict systems using PIDs 109, PFD creators 105 (which may be the same system designers 101 or other individuals) may also use the standard symbol library 111 to understand the information depicted in the PIDs 109 when creating the PFDs 113. For example, a PFD creator 105 may receive a PID 109 and use their knowledge of the standard symbol library to identify the symbols and connections depicted in the PID 109. With this understanding of the PID 109, the PFD creator 105 may create the PFDs 113 that represent the principle components involved in the processes performed by the system and the flow of materials through the process.

When the PFD creators 105 have created the PFDs 113, the PFDs 113 may be provided to site engineers 107 or other stakeholders who then use the PFDs 113 to more fully understand the processes performed by the systems depicted in the PIDs 109. This understanding may be acquired through simulations of different material quantities and compositions provided to the processes depicted in the PFDs 113 or through the simplified depictions of processes performed by the systems shown in the PIDs 109. Thus, the PFDs 113 facilitate understanding systems and their processes.

However, interpreting the PIDs 109 for creating PFDs 113 is time-intensive and prone to errors. Also, the standard symbol library 111 may be extensive and the standards definition bodies may periodically add new symbols to the standard symbol library 111, leading to challenges for PFD creators 105 when trying to understand all the symbols that may be presented within a PFD.

The oil refining industry provides an example of an industry that employs PIDs 109 and PFDs 113 to improve processes related to the refinement of oil products. For example, PIDs 109 are used to design, operate, and maintain oil refineries and oil-processing plants. PIDs 109 often depict piping networks and equipment (such as pumps, compressors, heat exchangers, and vessels) and provide details about valves, instrumentation, and control loops that manage oil production processes. Further, when an oil refinery plant is designed, the PIDs 109 are used to plan complex networks of pipelines, pumps, and process units used for oil refining, transportation, and storage. During operation, PIDs 109 are used to monitor the system and troubleshoot issues that arise during the operation of the system. Thus, PIDs 109 can be used to ensure that pressures, temperatures, and flow rates remain within safe operating limits. Also, when performing maintenance tasks, individuals can use the PIDs 109 to identify components that require service or replacement. Additionally, PIDs 109 may help maintenance workers isolate sections of a plant for performing maintenance work.

Additionally, the oil refining industry also benefits from using PFDs 113. For example, PFDs 113 provide a higher-level overview of major process steps and flows in oil processing facilities. These steps may include refining, separation, cracking, and the like. Often, PFDs 113 show the flow of hydrocarbons through the main pieces of equipment including distillation towers, reactors, separators, etc. However, the PFDs 113 does not focus on the details illustrated within the PIDs 109. Often engineers use PFDs 113 to improve the overall process design and how to process oil from a crude form to final products (like gasoline, diesel, lubricants, and the like). Also, PFDs can help in hazard analysis and safety evaluations. As they outline broad flow paths, they can be monitored to ensure system-wide safety compliance.

The pharmaceutical industry is another example of an industry that employs PIDs 109 and PFDs 113 to improve processes related to the production of pharmaceuticals. For example, the pharmaceutical industry is highly regulated and PIDs 109 are used to document precise piping, instrumentation, and equipment setups used in pharmaceutical production. Thus, PIDs 109 can be used to ensure and show compliance with manufacturing practices, regulatory standards, and quality control protocols. Additionally, PIDs 109 can document the flow of fluids, the use of sterilization equipment, and other equipment that is important for controlling the production environment. For example, PIDs 109 can detail how bioreactors, fermenters, filtration systems, dryers, and other equipment are connected to ensure that pharmaceutical production processes are tightly controlled and free from contaminants.

The pharmaceutical industry also benefits from the use of PFDs 113. PFDs 113 can provide a macro-level view of drug manufacturing processes, showing how ingredients flow through the different manufacturing processes. For example, a PFD 113 can show the various ingredients passing through stages that include synthesis, separation, purification, formulation, and other steps in the manufacture of drugs. Further, engineers can use PFDs 113 to outline an overall process when attempting to design efficient production lines as lab synthesis is scaled up to commercial production. Also, PFDs 113 can be used to provide documentation to regulatory bodies as they summarize how a production process meets quality standards. Additionally, as PFDs 113 show how resources are used by the components performing a process, PFDs 113 are helpful in performing resource management as they can highlight the inputs and outputs of resources involved in a process.

Mining industries provide a further example of an industry that employs PIDs 109 and PFDs 113 to improve processes related to the extraction of minerals. The mining industry uses PIDs 109 to represent piping systems and process control loops involved in extracting and refining minerals or ores. PIDs 109 are particularly useful because they can depict the details of circuits, conveyors, crushers, mills, flotation cells, thickening equipment, and other mining equipment. Thus, they are critical to managing the flow of ore and reagents used in the refining processes. PIDs 109 can also document instrumentation used to monitor the operation of mining processes. For example, they can document systems for monitoring pressures, flows, chemical levels, ore quantities, and other instrumentation systems. Maintenance teams can also use PIDs 109 for troubleshooting mining processes and ensuring that mining processes are operating safely as designed.

The mining industry also benefits from the use of PFDs 113. PFDs 113 can provide a broad view of the flow of material through major process stages in the extraction and refinement of minerals. For example, PFDs 113 can show material flows through process stages that include grinding, leaching, separation, and other extraction and refinement stages. In particular, a PFD 113 can outline how raw ore is transformed into valuable minerals as the ore passes through the extraction and refinement stages. Further, engineers can use PFDs 113 to improve the efficiency of extracting minerals from ore by using the PFDs 113 to evaluate the major material and energy inputs and outputs at key stages in mining processes. Additionally, environmental teams can use PFDs 113 to visualize waste streams so that they can adequately plan for the treatment of process waste and ensure compliance with environmental regulations.

Thus, as described above, PIDs 109 and PFDs 113 are useful in many industries. Thus, many industries can benefit from methods that can reduce the time needed to interpret and create PFDs 113 from PIDs 109. Further, these industries can also benefit from methods that are not prone to errors that arise due to human interpretation. Also, methods for interpreting PIDs 113 and generating PIDs 109 that can quickly accommodate and integrate changes to standard symbol library 111 can be widely beneficial. Thus, systems and methods described herein use machine learning methods to accurately and quickly generate PFDs 113 from PIDs 109 that are able to adapt to changes in symbol libraries across many industries.

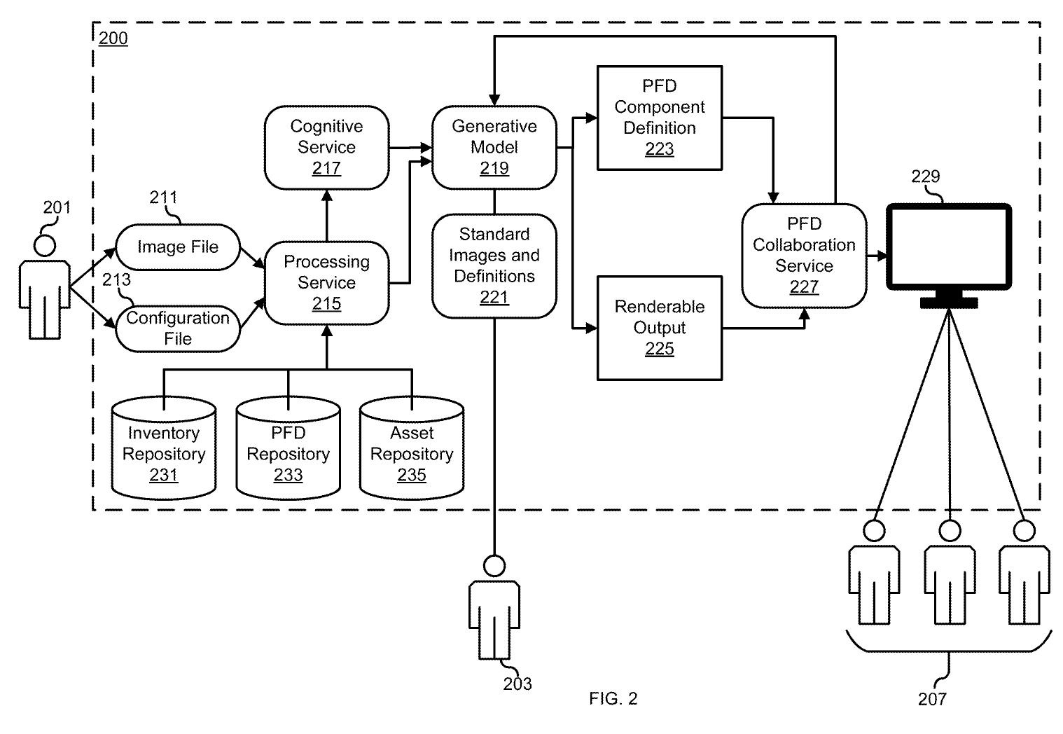

FIG. 2 illustrates a block diagram of a system 200 for using machine learning to generate PFD diagrams from PIDs. In particular, as shown in FIG. 2, a system 200 may include a cognitive service 217 and a generative module 219 as machine learning models to reduce the cost of creating PFDs while also creating PFDs that more accurately represent the processes performed by the systems depicted in PIDs.

In certain embodiments, the system 200 includes a generative model 219 and a cognitive service 217 that are produced using machine learning. As used herein, machine learning generally refers to computational methods for automating data analysis that enables computing systems to learn from data, identify patterns, and make decisions or generate additional information with minimal human intervention. Further, models produced using machine learning methods may be capable of improving performance over time as they adapt to additional data. Generally, training of a machine learning model is performed using one or more various learning paradigms. These learning paradigms include supervised learning, unsupervised learning, and reinforcement learning. When training the cognitive service 217 and the generative model 219 may use a combination of learning paradigms.

When a machine learning model, such as the generative model 219, is trained using supervised learning, the model is trained using labeled datasets. In particular, training data may include a dataset that is labeled, where the inputs to a model are known and output that should be produced by the model in response to the known inputs are also known. For example, the generative model 219 may learn relationships between the input data and the desired output during training. As the generative model 219 learns the relationship between the input data and associated outputs, the generative model 219 may improve its ability to make generalized predictions upon receiving new, unseen, or non-labeled data. Various machine learning algorithms may be used to train a model using supervised learning. These algorithms may include combinations of decision trees, support vector machines (SVM), neural networks, and the like.

When a machine learning model, such as the generative model 219, is trained using unsupervised learning, the learning is focused on identifying patterns in input data that lack labeled outputs. For example, in contrast to learning relationships between inputs and outputs, the generative model 219 may learn to organize data into groups or clusters based on similarities or hidden structures. Various machine learning algorithms may be used to train a model using unsupervised learning. These algorithms include clustering, principal component analysis, dimensionality reduction, among other unsupervised learning techniques.

When a machine learning model, such as the generative model 219, is trained using reinforcement learning, the generative model 219 learns through interaction with data received from outside the model and then receives feedback in the forms of rewards or penalties through the interactions. Through these interactions, the model learns to perform actions associated with rewards and to avoid actions associated with penalties. Reinforcement learning is an effective tool for training a model that performs decision-making and optimizing actions over time.

In some embodiments, the generative model 219 may be trained within a training environment. However, the training of the generative model 219 may be performed in a variety of processing environments. For example, the generative model 219 may be trained on a local computing system that is subsequently deployed to an operational environment, or the generative model 219 may be trained on a cloud-based platform. In some implementations, the training and operational environments 103 may be the same. For example, the training environment may be a cloud-based platform, and the generative model 219 is deployed within the same cloud-based platform. The selection of the training environment for the generative model 219 and the cognitive service 217 depends on the computational complexity and size of the generative model 219 and the cognitive service 217.

Where the training environment is a local computing environment, processors and memory used for training may be implemented on one or more locally operating computers, such as workstations or servers. Workstations and servers used to train machine learning models often include one or more high-performance CPUs or GPUs. However, local environments are often constrained in their processing capabilities and are generally used for training smaller-scale models or initial testing of machine learning algorithms. In contrast, where the training environment is a distributed system, the processors and memory used for training are implemented within multiple computing devices (like workstations and servers) distributed across one or more locations. Further, multiple computing devices often train models using parallel computation. These distributed processors and memory are often suitable for training models with larger datasets and complexity. Further, the training environment may be a cloud-based platform. As used herein, a cloud-based platform may refer to a service provided through the cloud that offers scalable resources for the training and deploying of machine learning models.

In certain embodiments, when training the generative model 219, processors may execute instructions that implement algorithms developed using a variety of programming languages and specialized libraries. For example, model developers may use programming languages such as Python, R, Java, C++, and Matlab, which offer different benefits. For example, model developers may use Python because it supports many libraries that facilitate the implementation of machine learning models. Model developers may use R to perform statistical analysis through libraries optimized for data exploration and modeling. Further, model developers may use Java for its scalability and production-ready solutions. Additionally, model developers may use C++ when the measurement prediction model 119 requires low-level memory management. Also, Matlab may be used for performing research into machine learning algorithms, performing prototyping, and data visualization. Other programming languages can be used as well depending on the characteristics of training the generative model 219 and the cognitive service 217.

As described herein, the generative model 219 and the cognitive service 217 may be trained using a single machine-learning algorithm. Alternatively, the generative model 219 and the cognitive service 217 may be trained as a machine learning ensemble that combines multiple learning algorithms to produce a single model. By using a machine learning ensemble, the training of the generative model 119 and the cognitive service 217 may aggregate the strengths of different learning algorithms and paradigms to achieve a higher model accuracy than would be available using a signal model.

To specifically use machine learning models to address the issues with the creation of PFDs, a computing system 200 may receive input drawings from an input stakeholder 201 and generate PFDs for use by output stakeholders 207. As used herein, the input drawings may be PIDs as described above, however, the input drawings may be other types of drawings and other non-drawing information that can be used by the computing system 200 to generate the PFDs. Also, while the generated output is described as PFDs, the output may include other types of process diagram drawings, where the process diagram drawings depict processes or other subsets of information that are depicted in the input drawings, or the output may depict information that is inferable from the information depicted in the input drawings. Also, the input stakeholder 201 may be an individual or group that intends to generate PFDs from input drawings. An input stakeholder 201 may be an engineer, a business owner, a maintenance individual, or another individual interested in the PFD. The output stakeholders 207 may be a similar individual to the input stakeholder 201, and it may be the same individual. However, in some embodiments, the output stakeholders 207 may additionally be responsible for reviewing the output PFDs provided by the computing system 200.

In certain embodiments, the input drawings may be provided by the input stakeholder 201 as image files 211 and/or configuration files 213. As used herein, image files 211 refer to files containing data that is renderable by software to display an image to a user. Examples of image files 211 include CAD files, PDF files, SVG files, JPEG files, among other formats for storing image data generally known to one having skill in the art. The configuration files 213 refer to files containing structured data related to the characteristics of the system represented in the image files 211 and the image files 211 themselves. Examples of configuration files 213 include spreadsheet information, XML files, database information, text files, and other file types that can convey information related to the systems.

In further embodiments, upon receiving the input drawings and other information from the input stakeholder 201, the computing system 200 may process the image files 211 and the configuration files 213 using a processing service 215. The processing service 215, as described herein, is configured to prepare the data in the image files 211 and the configuration files 213 for being input to machine learning models. For example, the processing service 215 may tokenize the data in the image files 211 and the configuration files 213, clean the data, and otherwise prepare it for being input to machine learning models.

Additionally, the processing service 215 may also access data stored by the computing system 200 related to the system depicted in the system. For example, the computing system may include memory devices that store data in computer-readable formats. The processing service 215 accesses the data stored on the memory devices and provides the data with information derived from the image files as inputs to models. For example, the processing service 215 may access data stored in at least one of an inventory repository 231, a PFD repository 233, and an asset repository 235. In particular, the processing service 215 may use the information to enhance the accuracy of generated PFD files by providing additional context that can be provided to models.

In additional embodiments, the asset repository 235 may define an asset hierarchy of an enterprise or stakeholder associated with the process depicted by the generated PFD. As used herein, the asset repository 235 may store information representing a structured description of physical assets used within a process depicted by a manufacturing process. The hierarchy described by the asset repository 235 may describe how an enterprise deploys, maintains, and manages assets. The assets may be high-level systems or individual components. Additionally, the asset repository 235 may describe how the different assets relate to each other in relation to processes implemented within a system. Further, the asset repository 235 may store an identifier for each asset that ties the asset back to the maintenance and management of the system performing the process.

In some embodiments, the inventory repository 231 may store information describing various inventories owned by an enterprise or stakeholder for the performance of the process. For example, the inventory repository may be a database describing the various inventories owned or operated by an enterprise/stakeholder that controls a process. The data in the inventory repository 231 may describe quantities of variable materials provided to the process, like raw materials, intermediate products, finished goods, spare parts, consumables, and tools employed for the performance of the process. Further, the inventory repository 231 may be a subset of the asset repository. However, the data in the inventory repository 231 may define assets consumed or sold as part of the process performed by the system. The materials defined in the inventory repository 231 may define materials that flow through the system and become part of a final product produced by the process or used to support the processes associated with the PFDs 113.

In further embodiments, the PFD repository 233 may provide information about different components that could be potentially represented by the symbols in the provided input image files 211. For example, the PFD repository 233 may describe a generalized, global set of symbols that describe components used in multiple industries. Alternatively, the PFD repository 233 may describe a domain-specific subset describing potential components used in a particular industry. When the PFD repository 233 describes the potential components that could arise in the input image files 211, the potential components may describe symbols that represent equipment, piping, valves, instruments, and control systems that could potentially be used in a process. The descriptions of the components may be associated with symbols defined in that are standard symbol libraries 111 defined by standards associations 103 and promulgated for use by system designers 101.

In certain embodiments, the processing service 215 may access the information stored in at least one of the inventory repository 231, PFD repository 233, and the asset repository 235 to provide additional information for the generation of PFDs in addition to the input image files 211 received from the input stakeholder 201. Accordingly, the PFDs may be generated using information about the asset hierarchy of the stakeholder as described in the asset repository 235 and information about variable materials as described in the inventory repository 231. Additionally, information about symbols and other information visually represented in the image files 211 may be provided from the PFD repository 233.

In some embodiments, generating a PFD from the image file may be computationally expensive. For example, the generation of the PFD may require a substantial amount of computational resources to generate the image file. In particular, when a generative machine learning model is used to generate PFDs, the computing system 200 may be hosted in a cloud environment containing many computational devices that are able to execute generative models stored on memory devices, where the generative models have many parameters (sometimes billions or even trillions of parameters). To perform calculations quickly with the large number of parameters involved in generative models may require large amounts of electricity and potentially time to generate any desired PFDs. Thus, if an input stakeholder 201 were to submit image files 211 that lack information that could be used to generate PFDs, a generative model 219 may perform costly computations to generate garbage PFDs from garbage input files. In addition to being computationally expensive, as described below, the computing system 200 may validate the model when the generative model 219 fails to recognize a symbol. The validation process may involve human intervention. Thus, providing image files that lack data from which useful PFDs 113 can be generated may also waste the time of individuals involved in the validation process.

To avoid providing bad image data to the generative model 219, the computing system 200 may include a cognitive service 217. As used herein, the cognitive service 217 may be a model that receives the image files 211 as input from the processing service 215 and returns an indication to the processing service 215 as to whether or not the image files 211 contain information that can be used to generate PFDs 113 by the generative model 219. If the cognitive service 217 returns an indication to the processing service 215 that the image files 211 contain information that can be used to generate PFDs 113 (like the PIDs 109), then the processing service 215 provides the image files 211 to the generative model 219. However, if the cognitive service 217 indicates to the processing service 215 that the image files 211 fail to contain information that can be used to generate PFDs 113, the processing service 215 will not provide the image files 211 to the generative model 219. Further, the processing service 215 may alert the input stakeholder 201 or other individual that the provided image files 211 failed to contain information from which PFDs 113 could be generated.

In certain embodiments, the cognitive service 217 may be a machine learning model trained to recognize whether the image files 211 contain information that can be used to generate PFDs 113. However, the cognitive service 217 may be implemented using other computational methods from machine learning to determine whether the image files 211 include PFD-related information. Whether or not the cognitive service 217 is a machine learning model, the execution of the cognitive service 217 is significantly less computationally intensive when compared to the execution of the generative model 219. Thus, the cognitive service 217 may save time and money by reducing the unnecessary consumption of resources by the generative model 219 that could arise from attempting to generate PFDs 113 from image files lacking PFD-related information.

In some embodiments, when the cognitive service 217 is a machine learning model, an individual or group of individuals, like data scientists 203, may train the cognitive service 217 to recognize images that contain PFD-related information. For example, to train the cognitive service 217, data scientists 203 may collect data, preprocess the data, select a model type suitable for image generation, train the model, and then evaluate and tune the model. After completing these tasks, the data scientists 203 may deploy the model as the cognitive service 217 to be used as described above within the computing system 200.

When collecting data for training the cognitive service 217, the data scientists 203 may acquire a large set of images. The set of images may include images that contain PFD-related information and images that lack PFD-related information. For example, the data scientists 203 may acquire a large number of PIDs 109 from which PFDs 113 have been created in the past. Also, the data scientists 203 may acquire a large number of other types of drawings and images unrelated to PFDs 113. The data scientists 203 select the information in the set of images to be representative of the potential drawings that could be provided by input stakeholders 201 to the processing service 215. Further, the data scientists 203 may acquire images containing PFD-related information of different quality so that the resultant cognitive service 217 is able to handle a large range and types of image files.

After collecting the set of images for training the cognitive service 217, the data scientists 203 may preprocess the collected images. For example, as the creation of the cognitive service 217 is a supervised learning task, each of the images used for training may be labeled with an indication as to whether the image contains PFD-related information. Further, each image may be resized to a consistent size to facilitate computational efficiency and to ensure uniformity across the dataset. When the data scientists 203 resize the images, they select an image size large enough to contain enough information for the cognitive service 217 to determine whether an image contains PFD-related data but small enough to increase the computational efficiency of the cognitive service 217. After deployment, the image files 211 may be similarly resized by the processing service 215 when provided to the cognitive service 217. In addition to resizing the images, the images may also be normalized and augmented. Normalization may help the model converge during training and the augmentation, where the images may be flipped, rotated, zoomed, cropped, and other image manipulations may help increase the size of the dataset, in turn helping increase the generalization capabilities of the resultant cognitive service 217.

When the data set has been preprocessed, the data scientists 203 may select a model algorithm and proceed with training the cognitive service 217. For example, the data scientists may train the cognitive service 217 using a convolutional neural network algorithm, transfer learning, autoencoders, support vector machines, recurrent neural networks, and the like. After selecting the model algorithm, the data scientists 203 may provide the images in the collected data set as inputs to the modeling algorithm. The modeling algorithm may then predict whether the provided image contains PFD-related information. The modeling algorithm then compares the prediction against the label for the image and attempts to minimize the loss function for the comparison of the predictions against the labels. Further, optimization and backpropagation algorithms may be employed to further minimize the loss. When the model has been trained, the trained cognitive service 217 may be validated using a separate set of labeled images (a validation set) that were not part of the training set of images. The modeling algorithm may fine-tune hyperparameters and check the model performance using the validation set. When the model achieves sufficient performance on the validation set, an additional set of testing images (separate from the training and validation set) may be used to test the performance of the cognitive service 217. If the model performs well with the testing set, the data scientists 203 may deploy the cognitive service 217 for use within the computing system 200 to determine whether the image files 211 contain PFD-related information.

In certain embodiments, when the cognitive service 217 determines that provided image files 211 contain PFD-related information, the cognitive service 217 conveys this determination to the processing service 215. In response to the determination that the image files 211 contain PFD-related information, the processing service 215 may provide the image files 211, related configuration files 213, and pertinent information found in the inventory repository 231, PFD repository 233, and asset repository 235 to the generative model 219. In some embodiments, the processing service 215 may perform some pre-processing on the input data sets before providing the information to the generative model 219. The pre-processing may include tokenizing, normalizing, resizing, cleaning, converting, among other pre-processing tasks that depend on the type of input data. Upon receiving the image files 211 and other related information from the processing service 215, the generative model 219 may generate information renderable by software applications as PFD data or information that can be provided to output stakeholders 207 for creating accurate PFDs 113.

In further embodiments, the generative model 219 provides the output to a PFD collaboration service 227, whereas the PFD collaboration service 227 renders the output from the generative model 219 for review by one or more output stakeholders 207. For example, the generative model 219 may produce a PFD component definition 223 and a renderable output 225. As used herein, the PFD component definition 223 may be a definition of the components identified in the image file 211 by the generative model 219 involved in a process depicted in a PFD. Further, the renderable output 225 may be data that the PFD collaboration service 227 may use in combination with the PFD component definition 223 to render a PFD for review by the output stakeholders 207 through a diagram visualization program.

In some embodiments, the generative model 219 may receive the prepared input from the processing service 215 and identify the processes depicted in the image file(s) 211. Alternatively, the prepared input may direct the generative model 219 to generate a PFD for a specified process depicted in the image file(s) 211. When the generative model 219 identifies a process, the generative model 219 then identifies the components depicted in the image file(s) 211 that are key contributors to the identified process. As used herein, a component is a key contributor to the identified process if the component is necessary to illustrate or related to the performance of the process in a PFD 113. Further, the components identified in the PFD component definition 223 may be components defined as part of a standard symbol library 111. In addition to identifying components associated with a PFD 113, the PFD component definition 223 may also define characteristics of the identified components. Characteristics may include assets used by a component, the inventory of assets used by a component, other components connected to a component, characteristics of connections, the function of a component, among other potential characteristics. The generative model 219 may generate the information found in the PFD component definition 223 in a file format that can be used to render a PFD from the components. For example, the generative model 219 may generate the PFD component definition 223 as a JavaScript objection notation (JSON) file or other type of file format that can describe objects in the PFD for multiple diagram visualization programs that can display PFDs. Alternatively, the generative model 219 may generate the PFD component definition 223 in a file format specific to a particular diagram visualization program.

In additional embodiments, the renderable output 225 may include information that can be rendered on a user interface to facilitate interaction with the output stakeholders 207. For example, the renderable output 225 may store data that guides the PFD collaboration service 227 to display the information defined in the PFD component definition 223. In some implementations, the generative model 219 may generate the renderable output 225 in a markup language, such as an HTML file, XML, or other type of markup language. In alternative embodiments, the generative model 219 may generate the PFD component definition 223 and the renderable output 225 in a single file that is specific to a particular PFD application.

In certain embodiments, the PFD collaboration service 227 receives the PFD component definition 223 and renderable output 225 and controls the display of the generated PFD on one or more user interfaces 229 for interacting with one or more output stakeholders 207. Additionally, the PFD collaboration service 227 may manage the interaction of the output stakeholders 207 with the PFD through the one or more user interfaces 229. For example, the PFD collaboration service 227 may manage changes made by the output stakeholders 207 to the PFD. The PFD collaboration service 227 may also store any changes made by the output stakeholders 207 to the generated PFD. The PFD collaboration service 227 may provide stored changes to data scientists 203 for improving the performance of the 219.

In some embodiments described herein, the data scientists 203 may also train the generative model 219 in addition to the cognitive service 217. However, the data scientists 203 may train the generative model 219 using different training algorithms than those used when training the cognitive service 217. Further, the generative model 219 may be significantly more complex when compared to the model deployed as the cognitive service 217.

When training the generative model 219, the data scientists 203 may use standard images and definitions 221 to create the training, validation, and testing data set. As used herein, the standard images and definitions 221 may include a symbol data set that contains image representations of symbols that are defined according to an industrial standard. Also, the standard images and definitions 221 may include a correlated data set of definitions that describe the symbols. Further, the definitions may include information describing context of the symbol that relates the symbol to information about assets, inventories and other symbols represented in potential images.

In further embodiments, when assembling the image representations of symbols that are defined according to an industrial standard, the data scientists 203 may acquire image representations of a particular symbol in a variety of sizes and qualities. For example, the images of the symbols may come from depictions that include noise and depictions having little noise. When depictions of symbols having noise are unavailable, the data scientists 203 may apply noise to some of the symbols. Further, the images of the symbols within the data set may also show a particular symbol within a context. For example, the images may show not only the symbol, but connections to the symbol, other components connected to the symbol, and images depicting a system that incorporate the symbol.

When assembling the definitions, the data scientist 203 may acquire textual information describing various configurations for each symbol. This information may include general information about the symbol, which may include information about the symbol as defined by a standards organization, such as the standard name of the symbol, general characteristics of the component that the symbol represents, what type of inputs and outputs are provided by the associated component, and the like. Additionally, the information may include context-specific information about the symbol. Context-specific information may include characteristics about a component associated with a symbol as depicted in a specific image. For example, the context information may characterize the connections to the symbols, flow rates of materials through the connections, sources of materials provided to the component, outputs of the component, destinations of the outputs, specific operational parameters of the component, assets associated with the component, inventories of materials associated with the component, and other context-specific information related to the component associated with the symbol.

In some embodiments, when the data scientist 203 has acquired the information to provide as inputs for training the model, the data scientist 203 may also acquire output information that represents the desired output of the generative model 219 when provided specific input information. In some implementations, the data scientist 203 may acquire a large set of PFDs and also image files and configuration information associated with each PFD. The data scientist 203 may then associate the input information with the associated PFD. The output information may also include lists of components included in an image file. Thus, the output data set used to train the generative model 219 may associate input information with examples of PFD component definitions 223 and renderable output 225.

When training the generative model 219, the data scientists 203 may use training data that is pertinent to a specific industry, where the training data includes a subset of the available symbols that are part of the symbol library defined by a standards organization. Thus, the resultant generative model 219 may be useful with respect to a specific industry. Alternatively, the data scientists 203 may use training data that comprehensively represents the available symbols that are part of a standard symbol library. Accordingly, the resultant generative model 219 may be used across a wide range of industries.

In certain embodiments, the data scientists 203 may use one or more machine learning algorithms to train the generative model 219. For example, the machine learning algorithms may be a convolutional neural networks (CNNs), Recurrent Neural Networks (RNNs), Long Short-Term Memory Networks (LSTMs), Transformer Networks, Generative Adversarial Networks (GANs), Variational Autoencoders, and other machine learning algorithms. In some implementations, the generative model 219 may be trained using a single machine learning algorithm. Alternatively, the training of the generative model 219 may be multi-modal.

In further embodiments, the data scientists 203 may divide the gathered data into different data sets to be used at various stages of the model training. For example, the collected data may be organized into training data, validation data, and testing data, in a similar manner as described above in relation to the training of the cognitive service 217. In particular, a large portion of the gathered data may be used to train the generative model 219. The training data set minimizes the loss between the predictions by the generative model 219 being trained and the gathered output data. When the loss becomes sufficiently small, the data scientists 203 may use the validation data (which is not part of the data used to train the generative model 219). The validation data may be used to adjust hyperparameters, check the performance of the model, and limit the overfitting of the generative model 219. If the generative model 219 fails validation, it can be trained further. If the generative model 219 passes validation, the data scientists 203 may then use the testing data (that is held separately from both the training and validation data) to test the performance of the generative model 219. If the generative model 219 passes the tests performed with the testing data, the data scientists 203 may then deploy the generative model 219 for use within the computing system 200. For example, the data scientists 203 may deploy the generative model 219 through cloud services for the generation of PFDs, or the data scientists 203 may provide a locally operable version of the generative model 219 for deployment.

In additional embodiments, after deployment of the generative model 219 for operation by the computing system 200, the computing system 200 may be able to provide additional operation during operation of the deployed generative model 219 to the data scientists 203 for further validation and training of the generative model 219. Thus, the performance of the generative model 219 may be improved as the generative model 219 is used to generate PFDs, leading to increased efficiency and accuracy in the creation of PFDs. In some implementations, the computing system 200 may additionally use feedback from the output stakeholders 207 to improve the performance of the generative model 219.

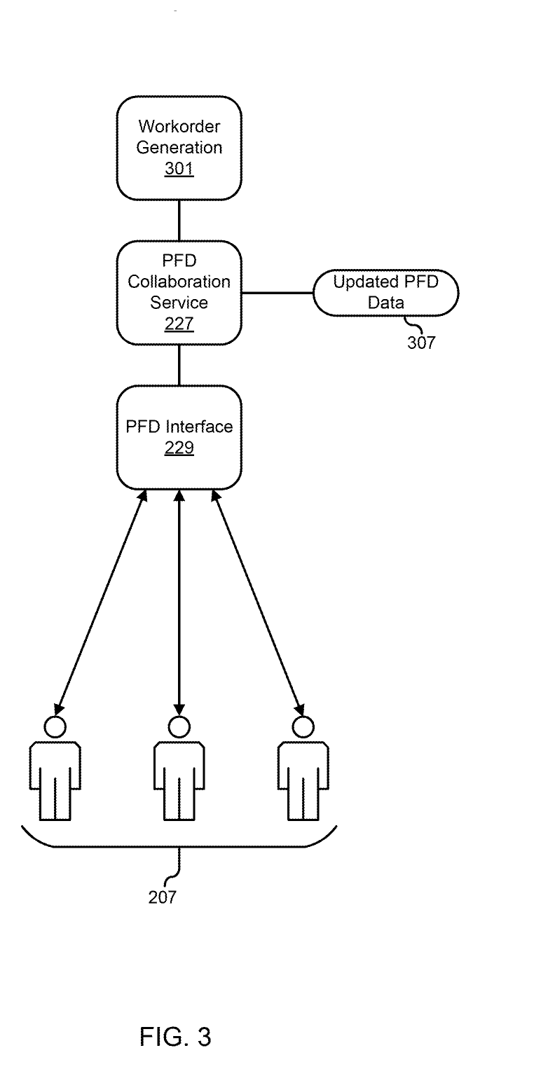

FIG. 3 illustrates a process 300 for monitoring changes to generated PFDs and using the monitored changes to validate and improve the performance of the generative model 219. In particular, the PFD collaboration service 227 may receive the PFD component definition 223 and the renderable output 225. As described, the PFD collaboration service 227 provides the PFD component definition 223 and the renderable output 225 to a computer application that displays a PFD based on interpreting the PFD component definition 223 and the renderable output 225, where the PFD is displayed on a PFD interface 229. Further, the PFD collaboration service 227 can also receive information from the output stakeholders 207 related to the displayed PFDs.

In certain embodiments, the PFD interface 229 may both display a generated PFD for review by the output stakeholders 207 and receive feedback regarding the generated PFD. For example, the PFD interface 229 may be a visual display on a computer monitor or other display device that displays the generated PFD to the output stakeholders 207. Also, the PFD interface 229 may include one or more devices for receiving feedback about the generated PFDs from the output stakeholders 207. Examples of such devices include computer mice, keyboards, or other devices for receiving input from one or more of the output stakeholders 207. As used herein, the feedback may include changes to the generated PFD, approval of generated PFDs and proposed changes, process simulations controlled by one or more of the output stakeholders 207, among other sources of information from the output stakeholders 207 related to the generated PFDs.

In some embodiments, the PFD collaboration service 227 may receive feedback from multiple output stakeholders 207. As feedback comes from different individuals, some of the feedback may have conflicts. The PFD collaboration service 227 may employ conflict resolution methodologies to resolve the conflicts. Also, when the feedback from the output stakeholders 207 includes changes to the generated PFD, the PFD collaboration service 227 may save the changes as updated PFD data 307. The PFD collaboration service 227 may provide the updated PFD data 307 as information for improving the performance of the generative model 219. Further, some of the changes and simulations performed by the output stakeholders 207 may call for changes to the system design or the physical system itself. In response to feedback from the output stakeholders 207 that call for changes to the system design or the physical system, the PFD collaboration service 227 may perform workorder generation 301. The workorder generation 301 may create lists of open tasks to be performed by one of system designers, maintenance individuals, or other individuals having responsibility to address the open tasks.

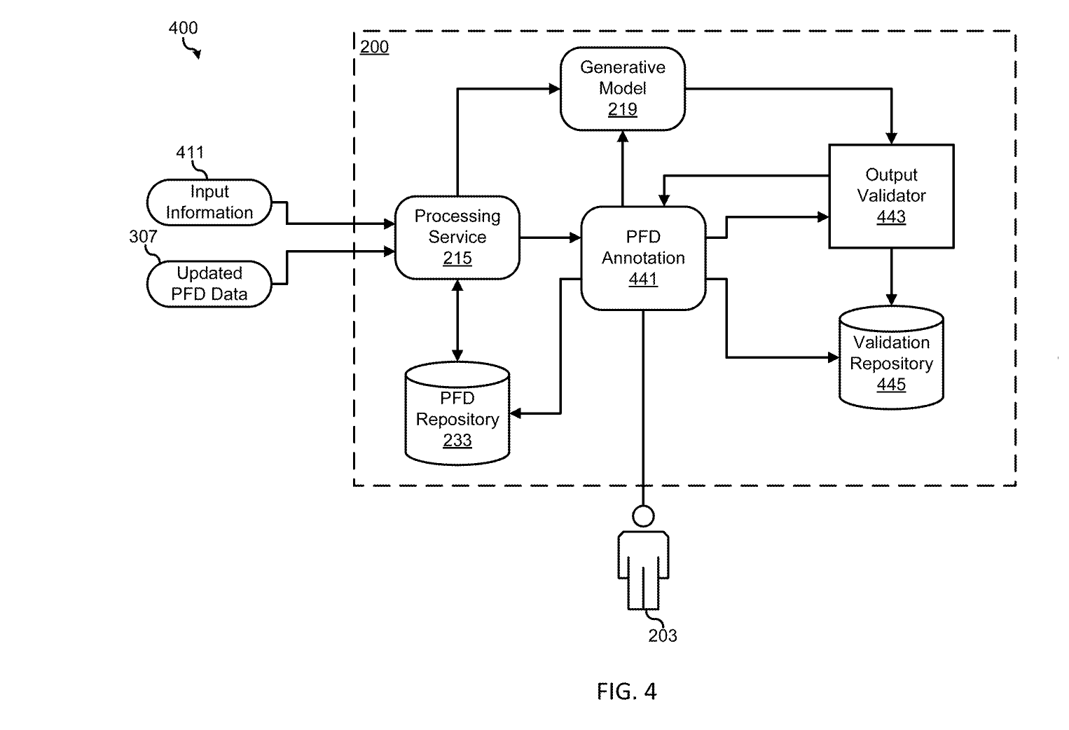

FIG. 4 illustrates a process 400 for validating and improving the performance of the generative model 219 in response to the updated PFD data 307. As described above, the processing service 215 receives input information 211. The input information may include input information 411 associated with a generated PFD. For example, the input information 411 may include the image files 211 and configuration files 213, which are provided as the input information 411. Also, the processing service 215 may receive the updated PFD data 307, which may include PFD changes made by the output stakeholders 207, names of components included in the changed PFD, a generated PFD associated with the changes, files used as inputs to the generative model 219, and other information that can help improve the performance of the generative model 219. The processing service 215 may use the updated PFD data 307 in conjunction with the input information 411 to identify symbols that the generative model 219 failed to correctly identify. Also, by using the PFD repository 233, the processing service 215 may also identify new components or components that were not part of the data used to train the generative model 219.

In particular, the processing service 215 may identify the components identified in the updated PFD data 307 and compare the identified components against the components identified in the PFD repository 233. If the processing service 215 identifies components not identified in the PFD repository 233, the processing service 215 may provide a list of unidentified components to a data scientist 203 as components to be annotated as PFD annotations 441. Also, the processing service 215 may provide other PFD changes as the PFD annotations 441, where the PFD annotations 441 contain information that can be used by data scientists 203 to train the generative model 219 further.

In certain embodiments, when the processing service 215 has provided information to the PFD annotations 441, the data scientists 203 may review the information stored in the PFD annotations 441. From the information stored in the PFD annotations 441, the data scientists 203 may identify additional places for improving the performance of the generative model 219. For example, the data scientists 203 may identify components that the generative model 219 is not identifying and components that the generative model 219 is misidentifying. In particular, the data scientists 203 may approve or update annotations with additional PFD components, definitions, and other related information. Further, the data scientists 203 may upload the updated PFD components to the PFD annotations 441 for additional training of the generative model 219. The updated PFD annotations may include inputs for additional training of the generative model 219 as well as expected outputs for the inputs.

In some embodiments, the PFD annotations 441 may then save the updated inputs in the PFD repository 233. Also, the PFD annotations 441 may save the expected outputs of the updated inputs in a validation repository 445. When the updated inputs are saved in the PFD repository 233 and the expected outputs are saved in the validation repository 445, the PFD annotations 441 may trigger additional training of the generative model 219. The additional training of the generative model 219 may perform the additional training using the updated inputs and the expected outputs in a similar manner as the initial training of the generative model 219. In particular, the PFD annotations 441 provide the updated inputs to the generative model 219 and save the produced outputs to an output validator 443.

In further embodiments, when the output validator receives the generated outputs from the 219, the output validator may acquire the expected outputs from the validation repository 445. The PFD annotations 441 then direct the output validator 443 to validate the generated outputs. In response, the output validator 443 will then compare the expected outputs to the generated outputs and determine results of the comparison. The results are then provided to the PFD annotations 441, which then adjusts the performance of the generative model 219 based on the results. Thus, the performance of the generative model 219 may continue to be improved after the deployment of the generative model 219.

In some embodiments, the various systems and methods described above may be performed by hardware or through the execution of instructions performed by one or more processors. For example, the processor and/or other computational devices may be implemented using software, firmware, hardware, or an appropriate combination thereof. The processors or other computational devices may be supplemented by, or incorporated in, specially-designed application-specific integrated circuits (ASICs) or field programmable gate arrays (FPGAs). The processors and other computational devices can also include or function with software programs, firmware, or other computer-readable instructions for carrying out various process tasks, calculations, and control functions used in the methods and systems described herein.

The methods described herein may be implemented or controlled by computer-executable instructions, such as program modules or components, executed by the one or more processors or other computing devices. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein may be implemented in software, firmware, or other computer-readable instructions. These instructions are typically stored on appropriate computer program products that include computer-readable media used to store computer-readable instructions or data structures. The computer-readable media may store computer-readable instructions or data structures. Such a computer-readable medium may be available media that can be accessed by a general-purpose or special-purpose computer or processor, or any programmable logic device.

Suitable computer-readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can carry or store desired program code as computer-executable instructions or data structures.

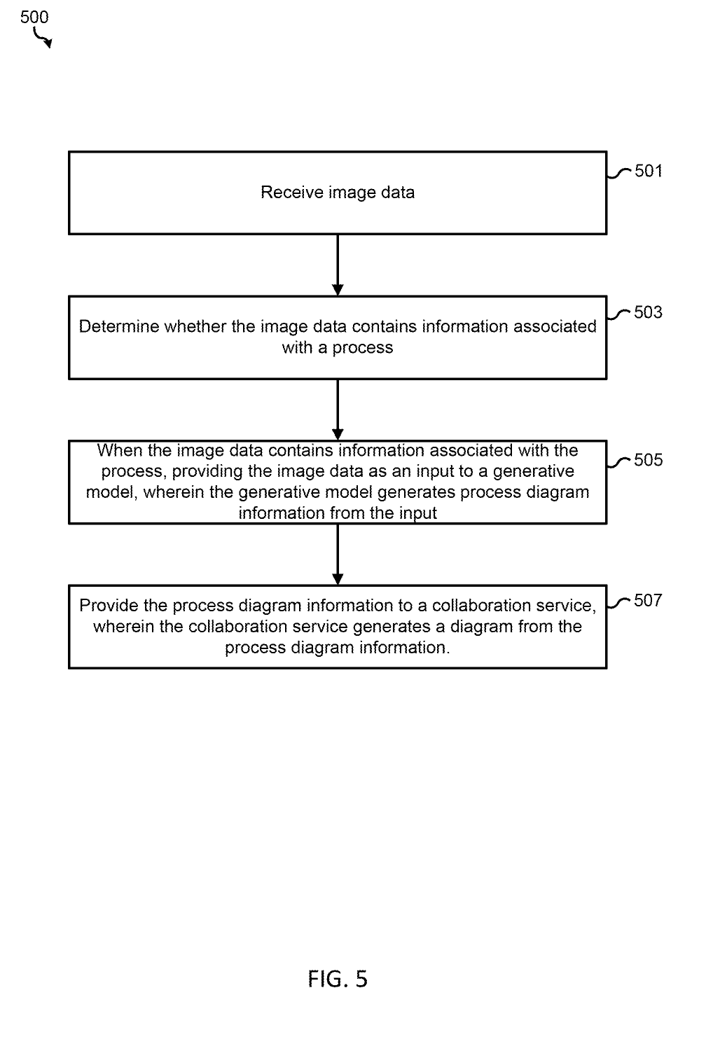

FIG. 5 is a flowchart diagram of a method 500 for generating industrial process flow diagrams using generative AI and image recognition. The method 500 proceeds at 501, where image data is received. Further, the method 500 proceeds at 503, where it is determined whether the image data contains information associated with a process. For example, the image data may be provided to a cognitive service that is trained to determine whether the image data contains information associated with a process. Additionally, when the image data contains information associated with the process, the method 500 proceeds at 505, where the image data is provided as an input to a generative model, wherein the generative model generates process diagram information from the input. Moreover, the method 500 proceeds at 507, wherein the process diagram information is provided to a collaboration service, wherein the collaboration service generates a diagram from the process diagram information.

### Example Embodiments

Example 1 includes a system comprising: one or more memory devices configured to store: a cognitive services model trained to determine whether image data represents process information; and a generative model trained to generate process diagram information from the image data; and one or more processors configured to: receive the image data; execute the cognitive services model to determine whether the image data contains information associated with a process; when the cognitive services model determines that the image data contains the information associated with the process, execute the generative model using the image data to generate the process diagram information; and provide the process diagram information to a diagram visualization program, wherein the diagram visualization program generates a diagram from the process diagram information.

Example 2 includes the system of Example 1, wherein, when generating the process diagram information, the generative model is trained to identify: symbols depicted in the image data; connections between the symbols; and relationships implied between the connections.

Example 3 includes the system of Example 2, wherein the symbols are derived from a set of symbols defined within an industry standard.

Example 4 includes the system of Example 3, wherein the generative model is periodically trained to incorporate new symbols added to the industry standard.

Example 5 includes the system of any of Examples 1-4, wherein the generative model is trained on at least one of: a domain-specific subset of symbols within a set of symbols; and a global set of symbols within the set of symbols representing multiple industry domains.

Example 6 includes the system of any of Examples 1-5, wherein the image data contain at least one of: image files; configuration data; asset information; and inventory information.

Example 7 includes the system of any of Examples 1-6, wherein the one or more processors is further configured to: receive corrections made by users to the diagram generated from the process diagram information; and perform additional training on at least one of the cognitive services model and the generative model based on the corrections.

Example 8 includes the system of any of Examples 1-7, wherein the one or more processors is further configured to: identify one or more definitions for approval in the image data; receive updated annotations and updated components for the one or more definitions; receive expected output when the updated components are provided as inputs to the generative model; and validate the generative model using the updated components and the expected output.

Example 9 includes the system of any of Examples 1-8, wherein the generative model generates image description data as at least one of javascript object notation information and hypertext markup language information, wherein a process flow diagram service renders diagrams based on the image description data.

Example 10 includes the system of any of Examples 1-9, wherein at least one of the cognitive services model and the generative model are deployed to users through a cloud platform.

Example 11 includes a method comprising: receiving image data; determining whether the image data contains information associated with a process; when the image data contains the information associated with the process, providing the image data as an input to a generative model, wherein the generative model generates process diagram information from the input; and providing the process diagram information to a collaboration service, wherein the collaboration service generates a diagram from the process diagram information.

Example 12 includes the method of Example 11, further comprising training the generative model to identify: symbols depicted in the image data; connections between the symbols; and relationships implied between the connections.

Example 13 includes the method of Example 12, wherein the symbols are derived from a set of symbols defined within an industry standard.

Example 14 includes the method of Example 13, wherein the generative model is periodically trained to incorporate new symbols added to the industry standard.

Example 15 includes the method of any of Examples 11-14, wherein the generative model is trained on at least one of: a domain-specific subset of symbols within a set of symbols; and a global set of symbols within the set of symbols representing multiple industry domains.

Example 16 includes the method of any of Examples 11-15, wherein the image data contain at least one of: image files; configuration data; asset information; and inventory information.

Example 17 includes the method of any of Examples 11-16, further comprising: receiving corrections made by users to the diagram generated from the process diagram information; and performing additional training of the generative model based on the corrections.

Example 18 includes the method of any of Examples 11-17, further comprising: identifying one or more definitions for approval in the image data; receiving updated annotations and updated components for the one or more definitions; receiving expected output when the updated components are provided as inputs to the generative model; and validating the generative model using the updated components and the expected output.

Example 19 includes the method of any of Examples 11-18, wherein the process diagram information comprises at least one of javascript object notation information and hypertext markup language information, wherein a process flow diagram service renders diagrams based on the process diagram information.

Example 20 includes a system comprising: one or more memory devices configured to store: a cognitive services model trained to determine whether image data represents process information; and a generative model trained to generate process diagram information from the image data; and one or more processors configured to: receive the image data; execute the cognitive services model to determine whether the image data contains information associated with a process; when the cognitive services model determines that the image data contains the information associated with the process, execute the generative model using the image data to generate the process diagram information; provide the process diagram information to a diagram visualization program, wherein the diagram visualization program generates a diagram from the process diagram information; receive updated diagram information for the diagram; and validate the generative model using the updated diagram information.

Although specific embodiments have been illustrated and described, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed:

1. A system comprising:
one or more memory devices configured to store:
a cognitive services model trained to determine whether image data represents process information; and
a generative model trained to generate process diagram information from the image data; and
one or more processors configured to:
receive the image data;
execute the cognitive services model to determine whether the image data contains information associated with a process;
when the cognitive services model determines that the image data contains the information associated with the process, execute the generative model using the image data to generate the process diagram information; and
provide the process diagram information to a diagram visualization program, wherein the diagram visualization program generates a diagram from the process diagram information.

2. The system of claim 1, wherein, when generating the process diagram information, the generative model is trained to identify:
symbols depicted in the image data;
connections between the symbols; and
relationships implied between the connections.

3. The system of claim 2, wherein the symbols are derived from a set of symbols defined within an industry standard.

4. The system of claim 3, wherein the generative model is periodically trained to incorporate new symbols added to the industry standard.

5. The system of claim 1, wherein the generative model is trained on at least one of:
a domain-specific subset of symbols within a set of symbols; and
a global set of symbols within the set of symbols representing multiple industry domains.

6. The system of claim 1, wherein the image data contain at least one of:
image files;
configuration data;
asset information; and
inventory information.

7. The system of claim 1, wherein the one or more processors is further configured to:
receive corrections made by users to the diagram generated from the process diagram information; and
perform additional training on at least one of the cognitive services model and the generative model based on the corrections.

8. The system of claim 1, wherein the one or more processors is further configured to:
identify one or more definitions for approval in the image data;
receive updated annotations and updated components for the one or more definitions;
receive expected output when the updated components are provided as inputs to the generative model; and
validate the generative model using the updated components and the expected output.

9. The system of claim 1, wherein the generative model generates image description data as at least one of javascript object notation information and hypertext markup language information, wherein a process flow diagram service renders diagrams based on the image description data.

10. The system of claim 1, wherein at least one of the cognitive services model and the generative model are deployed to users through a cloud platform.

11. A method comprising:
receiving image data;
determining whether the image data contains information associated with a process;
when the image data contains the information associated with the process, providing the image data as an input to a generative model, wherein the generative model generates process diagram information from the input; and
providing the process diagram information to a collaboration service, wherein the collaboration service generates a diagram from the process diagram information.

12. The method of claim 11, further comprising training the generative model to identify:
symbols depicted in the image data;
connections between the symbols; and
relationships implied between the connections.

13. The method of claim 12, wherein the symbols are derived from a set of symbols defined within an industry standard.

14. The method of claim 13, wherein the generative model is periodically trained to incorporate new symbols added to the industry standard.

15. The method of claim 11, wherein the generative model is trained on at least one of:
a domain-specific subset of symbols within a set of symbols; and
a global set of symbols within the set of symbols representing multiple industry domains.

16. The method of claim 11, wherein the image data contain at least one of:
image files;
configuration data;
asset information; and
inventory information.

17. The method of claim 11, further comprising:
receiving corrections made by users to the diagram generated from the process diagram information; and
performing additional training of the generative model based on the corrections.

18. The method of claim 11, further comprising:
identifying one or more definitions for approval in the image data;
receiving updated annotations and updated components for the one or more definitions;
receiving expected output when the updated components are provided as inputs to the generative model; and
validating the generative model using the updated components and the expected output.

19. The method of claim 11, wherein the process diagram information comprises at least one of javascript object notation information and hypertext markup language information, wherein a process flow diagram service renders diagrams based on the process diagram information.

20. A system comprising:
one or more memory devices configured to store:
a cognitive services model trained to determine whether image data represents process information; and
a generative model trained to generate process diagram information from the image data; and
one or more processors configured to:
receive the image data;
execute the cognitive services model to determine whether the image data contains information associated with a process;
when the cognitive services model determines that the image data contains the information associated with the process, execute the generative model using the image data to generate the process diagram information;
provide the process diagram information to a diagram visualization program, wherein the diagram visualization program generates a diagram from the process diagram information;
receive updated diagram information for the diagram; and
validate the generative model using the updated diagram information.
